(19) United States
(12) Patent Application Publication
(10) Pub. No.: US 2007/0167530 A1
(43) Pub. Date: Jul. 19, 2007

(54) Method for depletion of sulphur and/or compounds containing sulphur from a biochemically produced organic compound

(75) Inventors: Till Gerlach, Ludwigshafen (DE); Johann-Peter Melder, Bohl-Iggelheim (DE); Bram Willem Hoffer, Heidelberg (DE); Anton Meier, Birkenheide (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/583,409

(22) PCT Filed: Dec. 22, 2004
(86) PCT No.: PCT/EP04/14591

§ 371 Date: Jun. 20, 2006

(30) Foreign Application Priority Data
Dec. 23, 2003 (DE) 103 61 508.3

(51) Int. Cl. A61K 31/045; C12P 7/06; C07C 29/76

(52) U.S. Cl. 514/724; 435/161; 568/917

(57) ABSTRACT

Method of reducing the concentration of sulfur and/or a sulfur-containing compound in a biochemically prepared organic compound by bringing the respective organic compound into contact with an adsorbent. Ethanol which has a particular specification and can be prepared by the abovementioned method, and its use as solvent, disinfectant, as component in pharmaceutical or cosmetic products or in foodstuffs or in cleaners, as feed in steam reforming processes for the synthesis of hydrogen or in fuel cells, or as building block in chemical synthesis.

The present invention relates to a method of reducing the concentration of sulfur and/or sulfur-containing compounds in a biochemically prepared organic compound, ethanol which can be prepared by this method and its use.

There is an increasing demand for biochemically prepared chemical compounds, e.g. compounds prepared by fermentation, as, for example, building blocks in the chemical synthesis of high-value chemicals or as “green” fuels.

(Cf., for example, H. van Bekkum et al., Chem. for Sustainable Development 11, 2003, pages 11-21).

Examples of these renewable resources are alcohols such as ethanol, butanol and methanol, diols such as 1,3-propanediol and 1,4-butanediol, triols such as glycerol, carboxylic acids such as lactic acid, acetic acid, propionic acid, citric acid, butyric acid, formic acid, malonic acid and succinic acid.

In place of synthetic ethanol, which is produced predominantly by hydration of ethylene, ethanol from biological sources, known as bioethanol, can also be used for many applications.

Instead of synthetic 1,3-propanediol, which is predominantly prepared by hydrolysis of acrolein to 3-hydroxypropanal in the presence of an acid catalyst followed by metal-catalyzed hydrogenation or by hydroformylation of ethylene oxide (Industrial Organic Chemistry, Weissermel and Arpe, 2003), 1,3-propanediol from biological sources, known as bio-1,3-propanediol, can also be used for many applications (U.S. Pat. No. 6,514,733, DE-A-38 29 618).

Instead of synthetic lactic acid prepared by hydrolysis of lactonitrile, lactic acid from biological sources can also be used for many applications (K. Weissermel and H.-J. Arpe, Industrial Organic Chemistry, Wiley-VCH, Weinheim, 2003, p. 306).

Edible oils and animal fats can be transesterified to produce biodiesel. In addition to biodiesel, a glycerol fraction is formed in this process. Uses of glycerol comprise applications in the chemical industry, for instance the preparation of pharmaceuticals, cosmetics, polyether isocyanates, glycerol tripolyethers (K. Weissermel and H.-J. Arpe, Industrial Organic Chemistry, Wiley-VCH, Weinheim, 2003, p. 303).

Uses of ethanol comprise applications in the chemical industry, for instance the preparation of ethylamines, the preparation of ethyl esters from carboxylic acids (in particular ethyl acetate), the preparation of butadiene or ethylene, the preparation of ethyl acetate via acetaldehyde and the preparation of ethyl chloride (K. Weissermel and H.-J. Arpe, Industrial Organic Chemistry, Wiley-VCH, Weinheim, 2003), and in the cosmetics and pharmaceuticals industry or in the food industry and also in cleaners, solvents and paints (N. Schmitz, Bioethanol in Deutschland, Landwirtschaftsverlag, Monster, 2003).

Further uses are: feed in steam reforming processes and hydrogen source in fuel cells (S. Velu et al., Cat. Letters 82, 2002, pages 145-52; A. N. Fatsikostas et al., Cat. Today 75, 2002, pages 145-55; F. Aupretre et al., Cat. Commun. 3, 2002, pages 263-67; V. Fierro et al., Green Chem. 5, 2003, pages 20-24; M. Wang, J. of Power Sources 112, 2002, pages 307-321).

Uses of 1,3-propanediol comprise applications in the chemical industry, for instance the production of pharmaceuticals, polyesters, polytrimethylene terephthalates, fibers.

Uses of lactic acid are in the food industry and in the production of biodegradable polymers.

The use of biochemically prepared compounds such as bioethanol, bio-1,3-propanediol or lactic acid, especially in particularly pure form, would be more advantageous and cheaper in many of these applications.

The purification or isolation of the biochemically prepared compounds is frequently carried out by distillation in complicated, multistage processes.

However, the advantage of the respective biochemically prepared compound is, as has been recognized according to the invention, frequently decreased by the compound comprising small amounts of sulfur and/or sulfur-containing compounds, in particular specific sulfur compounds, even after the known purification processes and the sulfur or the sulfur-containing compounds frequently interfering in the respective applications.

Thus, the sulfur content of bioethanol interferes in its use in ammination to form ethylamines by poisoning the metal catalyst. A similar situation applies in amminations of other bioalcohols.

The ammination of alcohols is carried out industrially over hydrogenation/dehydrogenation catalysts, in particular heterogeneous hydrogenation/dehydrogenation catalysts, by reaction of the respective alcohol with ammonia, primary or secondary amines at elevated pressure and elevated temperature in the presence of hydrogen. C.f., for example, Ullmann's Encyclopedia of Industrial Chemistry, sixth edition, 2000, ‘Aliphatic Amines: Production from alcohols’.

The catalysts usually comprise transition metals, for instance metals of groups VIII and IB, often copper, as catalytically active components which are frequently applied to an inorganic support such as aluminum oxide, silicon dioxide, titanium dioxide, carbon, zirconium oxide, zeolites, hydrotalcites and similar materials known to those skilled in the art.

If the corresponding bioalcohol is used, the catalytically active metal surface of the heterogeneous catalysts becomes coated with the sulfur or sulfur compounds introduced via the bioalcohol to an increasing extent over time. This leads to accelerated catalyst deactivation and thus to a significant deterioration in the economics of the respective process.

The sulfur content of bioethanol also has an adverse effect due to poisoning of the catalyst, e.g. in steam reforming processes for the production of hydrogen and in fuel cells.

In general, the sulfur content of chemicals derived from natural raw materials will have an adverse effect on a reaction carried out using them, for instance as a result of, as described, metal centers being sulfurized and thereby deactivated, or acidic or basic centers being occupied, secondary reactions occurring or being catalyzed, formation of deposits in production plants and contamination of the products.

A further adverse effect of sulfur and/or sulfur-containing compounds in the biochemically prepared compounds is their typical unpleasant odor which is disadvantageous, in particular, in cosmetic applications, in disinfectants, in foodstuffs and in pharmaceutical products.

It is therefore of great economic interest to reduce the concentration of sulfur and/or sulfur-containing compounds in biochemically prepared organic compounds such as bioethanol, bio-1,3-propanediol, bio-1,4-butanediol, bio-1-butanol (in general: bioalcohols), or to remove the sulfur and/or the sulfur-containing compounds virtually entirely, by means of a desulfurization step preceding their use.

WO-A-2003 020850, US-A1-2003 070966, US-A1-2003 113598 and U.S. Pat. No. B1-6,531,052 concern the removal of sulfur from liquid hydrocarbons (petroleum spirit).

Chemical Abstracts No. 102: 222463 (M. Kh. Annagiev et al., Doklady-Akademiya Nauk Azerbaidzhanskoi SSR, 1984, 40 (12), 53-6) describes decreasing the concentration of S compounds in technical-grade ethanol (not bioethanol) from 25-30 to 8-17 mg/l by bringing the ethanol into contact with zeolites of the clinoptilolite and mordenite types at room temperature, with the zeolites having been conditioned beforehand at 380° C. for 6 hours and in some cases treated with metal salts, in particular Fe₂O₃. The S compounds removed are H₂S and alkyl thiols (R—SH).

It was an object of the present invention to discover an improved economical method of treating biochemically prepared organic compounds such as bioalcohols, e.g. bioethanol, by means of which the corresponding treated compound is obtained in high yield, space-time yield and selectivity and which when used, for example, in chemical synthetic processes such as the preparation of ethylamines, in particular monoethylamine, diethylamine and triethylamine, from bioethanol, and also in other applications, e.g. in the chemical, cosmetic or pharmaceutical industry or in the food industry, has improved properties.

In particular, the use of a treated bioethanol should make increased catalyst operating lifes in the synthesis of ethylamines possible.
(Space-time yields are reported in ‘amount of product/(catalyst volume·time)’ (kg/(I_{cat}·h)) and/or ‘amount of product/(reactor volume·time)’ (kg/(I_{reactor}·h)).

We have accordingly found a method of reducing the concentration of sulfur and/or a sulfur-containing compound in a biochemically prepared organic compound, which comprises bringing the respective organic compound into contact with an adsorbent.

Furthermore, ethanol which has a particular specification (see below) and can be prepared by the abovementioned method and its use as solvent, disinfectant, as component in pharmaceutical or cosmetic products or in foodstuffs or in cleaners, as feed in steam reforming processes for the synthesis of hydrogen or in fuel cells or as building block in chemical synthesis has been found.

The method of the invention is particularly useful for reducing the concentration of sulfur or a sulfur-containing compound in a compound prepared by fermentation.

The sulfur-containing compounds are inorganic or organic compounds, in particular symmetrical or unsymmetrical C₂₋₁₀-dialkyl sulfides, particularly C₂₋₆-dialkyl sulfides such as diethyl sulfide, di-n-propyl sulfide, diisopropyl sulfide, very particularly dimethyl sulfide, C₂₋₁₀-dialkyl sulfoxides such as dimethyl sulfoxide, diethyl sulfoxide, dipropyl sulfoxide, 3-methylthio-1-propanol and/or S-containing amino acids such as methionine and S-methylmethionine.

The biochemically prepared organic compound is preferably an alcohol, ether or a carboxylic acid, in particular ethanol, 1,3-propanediol, 1,4-butanediol, 1-butanol, glycerol, tetrahydrofuran, lactic acid, succinic acid, malonic acid, citric acid, acetic acid, propionic acid, 3-hydroxypropionic acid, butyric acid, formic acid or gluconic acid.

As adsorbents, preference is given to using a silica gel, an activated aluminum oxide, a zeolite having hydrophilic properties, an activated carbon or a carbon molecular sieve.

Examples of silica gels which can be used are silicon dioxide, examples of aluminum oxides which can be used are boehmite, gamma-, delta-, theta-, kappa-, chi- and alpha-aluminum oxide, examples of activated carbons which can be used are carbons produced from wood, peat, coconut shells, or synthetic carbons and carbon blacks produced, for instance, from natural gas, petroleum or downstream products, or polymeric organic materials which can also comprise heteroatoms such as nitrogen, and examples of carbon molecular sieves which can be used are molecular sieves produced from anthracite and hard coal by partial oxidation, and these are described, for example, in the electronic version of the sixth edition of Ullmann's Encyclopedia of Industrial Chemistry, 2000, Chapter Adsorption, Paragraph ‘Adsorbents’.

If the adsorbent is produced as shaped bodies, for instance for a fixed-bed process, it can be used in any desired shape. Typical shaped bodies are spheres, extrudates, hollow extrudates, star extrudates, pellets, crushed material, etc., having characteristic diameters of from 0.5 to 5 mm, or monolites and similar structured packing elements (cf. Ullmann's Encyclopedia, sixth edition, 2000 Electronic Release, Chapter Fixed-Bed Reactors, Par. 2: Catalyst Forms for Fixed-Bed Reactors).

In the case of a suspension procedure, the adsorbent is used in powder form. Typical particle sizes in such powders are 1-100 μm, but it is also possible to use particles significantly smaller than 1 μm, for instance when using carbon black. The filtration in suspension processes can be carried out batchwise, for instance by deep bed filtration. In continuous processes, crossflow filtration, for example, is a possibility.

Adsorbents used are preferably zeolites, in particular zeolites from the group consisting of natural zeolites, faujasite, X-zeolite, Y-zeolite, A-zeolite, L-zeolite, ZSM 5 zeolite, ZSM 8 zeolite, ZSM 11 zeolite, ZSM 12 zeolite, mordenite, beta-zeolite, pentasil zeolite and mixtures thereof which contain ion-exchangeable cations.

Such zeolites, including commercial zeolites, are described in Kirk-Othmer Encyclopedia of Chemical Engineering 4th Ed. Vol 16. Wiley, NY, 1995, and also, for example, in Catalysis and Zeolites, J. Weitkamp and L. Puppe, Eds, Springer, Berlin (1999).

It is also possible to use metal organic frameworks (MOFs) (e.g. Li et al., Nature, 402, 1999, pages 276-279).

The cations of the zeolite, e.g. H⁺ in the case of a zeolite in the H form or Na⁺ in the case of a zeolite in the Na form, are preferably completely or partly replaced by metal cations, in particular transition metal cations. (Loading of the zeolites with metal cations).

This can be carried out by, for example, ion exchange, impregnation or evaporation of soluble salts. However, the metals are preferably applied to the zeolite by ion exchange, since they then have, as recognized according to the invention, a particularly high dispersion and thus a particularly high sulfur adsorption capacity. Cation exchange can be carried out, for example, starting from zeolites in the alkali metal, H or ammonium form. In Catalysis and Zeolites, J. Weitkamp and L. Puppe, Eds., Springer, Berlin (1999), such ion exchange techniques for zeolites are described comprehensively.

Preferred zeolites have a modulus (molar SiO₂:Al₂O₃ ratio) in the range from 2 to 1000, in particular from 2 to 100.

Very particular preference is given to using adsorbents, in particular zeolites, comprising one or more transition metals, in elemental or cationic form, from groups VIII and IB of the Periodic Table, e.g. Fe, Co, Ni, Ru, Rh, Pd, Os, Ir, Pt, Cu, Ag and/or Au, preferably Ag and/or Cu, in the method of the invention.

The adsorbent preferably comprises from 0.1 to 75% by weight, in particular from 1 to 60% by weight, particularly preferably from 2 to 50% by weight, very particularly preferably from 5 to 30% by weight, (in each case based on the total mass of the adsorbent) of the metal or metals, in particular the transition metal or transition metals.

Processes for preparing such metal-containing adsorbents are known to those skilled in the art, e.g. from Larsen et al., J. Chem. Phys. 98, 1994 pages 11533-11540 and J. Mol. Catalysis. A, 21 (2003) pages 237-246.

In Catalysis and Zeolites, J. Weitkamp and L. Puppe, Eds, Springer, Berlin (1999), ion exchange techniques for zeolites are described comprehensively.

For example, A. J. Hemandez-Maldonado et al. in Ind. Eng. Chem. Res. 42, 2003, pages 123-29, describe a suitable method for preparing an Ag—Y-zeolite by ion exchange of Na—Y-zeolite with an excess of silver nitrate in aqueous solution (0.2 molar) at room temperature over 24-48 hours. After the ion exchange, the solid is isolated by filtration, washed with large amounts of deionized water and dried at room temperature.

In addition, T. R. Felthouse et al., J. of Catalysis 98, pages 411-33 (1986), for example, describe the preparation of the respective Pt-containing zeolites from the H forms of Y-zeolite, mordenite and ZSM-5.

The methods disclosed in WO-A2-03/020850 for preparing Cu—Y— and Ag—Y-zeolites by ion exchange from Na—Y-zeolites are also suitable for obtaining adsorbents preferred for the method of the invention.

Very particularly preferred adsorbents are:

Ag—X-zeolite having an Ag content of from 10 to 50% by weight (based on the total mass of the adsorbent) and

Cu—X-zeolite having a Cu content of from 10 to 50% by weight (based on the total mass of the adsorbent).

To carry out the method of the invention, the adsorbent is generally brought into contact with the organic compound at temperatures in the range from 0° C. to 200° C., in particular from 10° C. to 50° C.

The contacting with the adsorbent is preferably carried out at an absolute pressure in the range from 1 to 200 bar, in particular from 1 to 5 bar.

It is particularly preferably carried out at room temperature and under atmospheric pressure.

In a preferred embodiment of the method of the invention, the respective organic compound is brought into contact with the adsorbent in the liquid phase, i.e. in liquid form or dissolved or suspended in a solvent or diluent.

Possible solvents are, in particular, those which are able to dissolve the compounds to be purified virtually completely or are completely miscible with these and are inert under the process conditions.

Examples of suitable solvents are water, cyclic and alicyclic ethers, e.g. tetrahydrofuran, dioxane, methyl tert-butyl ether, dimethoxyethane, dimethoxypropane, dimethyl diethylene glycol, aliphatic alcohols such as methanol, ethanol, n-propanol or isopropanol, n-butanol, 2-butanol, isobutanol or tert-butanol, carboxylic esters such as methyl acetate, ethyl acetate, propyl acetate or butyl acetate, and also aliphatic ether alcohols such as methoxypropanol.

The concentration of the compound to be purified in the liquid, solvent-containing phase can in principle be chosen freely and is frequently in the range from 20 to 95% by weight, based on the total weight of the solution/mixture.

One variant of the method of the invention comprises carrying it out in the presence of hydrogen under atmospheric pressure or superatmospheric pressure.

The method can be carried out in the gas or liquid phase, in the fixed-bed or suspension mode, with or without backmixing, continuously or batchwise according to the methods known to those skilled in the art (e.g. as described in Ullmann's Encyclopedia, sixth edition, 2000 electronic release, Chapter “Adsorption”).

To obtain a very high reduction in the concentration of the sulfur compound, processes having a low degree of backmixing are particularly useful.

The method of the invention makes it possible, in particular, to reduce the concentration of sulfur and/or sulfur-containing compounds in the respective compound by ≧90% by weight, particularly preferably ≧95% by weight, very particularly preferably ≧98% by weight (in each case calculated as S).

The method of the invention makes it possible, in particular, to reduce the concentration of sulfur and/or sulfur-containing compounds in the respective compound to a residual content of <2 ppm by weight, particularly preferably <1 ppm by weight, very particularly preferably from 0 to <0.1 ppm by weight (in each case calculated as S), for example determined by the Wickbold method (DIN EN 41).

The bioethanol which is preferably used in the method of the invention is generally produced from agricultural products such as molasses, cane sugar juice, maize starch or from products of wood saccharification and from sulfite waste liquors by fermentation.

Preference is given to using bioethanol which has been obtained by fermentation of glucose with elimination of CO₂ (K. Weissermel and H.-J. Arpe, Industrial Organic Chemistry, Wiley-VCH, Weinheim, 2003, p. 194; Electronic Version of Sixth Edition of Ullmann's Encyclopedia of Industrial Chemistry, 2000, Chapter Ethanol, Paragraph Fermentation). The ethanol is generally isolated from the fermentation broths by distillation methods: Electronic Version of Sixth Edition of Ullmann's Encyclopedia of Industrial Chemistry, 2000, Chapter Ethanol, Paragraph Recovery and Purification.

According to the invention, the ethanol prepared using the method found is advantageously used

as building block in chemical synthesis, e.g.

in processes (known to those skilled in the art) for preparing a primary, secondary or tertiary ethylamine, a monoethylamine or diethylamine, in particular monoethylamine, diethylamine and/or triethylamine, by reacting the ethanol with NH₃, a primary amine or a secondary amine in the presence of hydrogen at elevated temperatures and pressures in the presence of a heterogeneous catalyst comprising a metal of group VIII and/or IB of the Periodic Table,

in processes (known to those skilled in the art) for preparing an ethyl ester, in particular by esterification of ethanol with a carboxylic acid or transesterification of a carboxylic ester with ethanol,

in processes (known to those skilled in the art) for preparing ethylene by dehydration,

as solvent, disinfectant, and

as component in pharmaceutical or cosmetic products or in foodstuffs or in cleaners, as feed in steam reforming processes for the synthesis of hydrogen or in fuel cells.

The present invention also provides an ethanol which can be prepared using the method of the invention and has

a content of sulfur and/or sulfur-containing organic compounds in the range from 0 to 2 ppm by weight, preferably from 0 to 1 ppm, particularly preferably from 0 to 0.1 ppm (in each case calculated as S), for example determined by the Wickbold method (DIN EN 41).

a content of C₃₋₄-alkanols in the range from 1 to 5000 ppm by weight, preferably from 5 to 3000 ppm by weight, particularly preferably from 10 to 2000 ppm by weight,

a methanol content in the range from 1 to 5000 ppm by weight, preferably from 5 to 3000 ppm by weight, particularly preferably from 10 to 2000 ppm by weight,

an ethyl acetate content in the range from 1 to 5000 ppm by weight, preferably from 5 to 3000 ppm by weight, particularly preferably from 10 to 2000 ppm by weight, and

a 3-methyl-1-butanol content in the range from 1 to 5000 ppm by weight, preferably from 5 to 3000 ppm by weight, particularly preferably from 10 to 2000 ppm by weight.

The content of C₃₋₄-alkanols, methanol, ethyl acetate and 3-methyl-1-butanol is, for example, determined by means of gas chromatography (30m DB-WAX column, internal diameter 0.32 mm, film thickness: 0.25 μm, FID, temperature program: 35° C. (5 min), 10° C./min, heating rate: 200° C. (8 min.).

### EXAMPLES

Preparation of Ag-Zeolites

### Example 1

### AG-Zeolite Powder

A solution of AgNO₃ (7.71 g of AgNO₃ in water, 200 ml total) was placed in a glass beaker, the zeolite (ZSM-5, 200 g, molar SiO₂/Al₂O₃ ratio=40-48, Na form) was slowly added while stirring and the mixture was stirred at room temperature for 2 hours. The adsorbent was then filtered off via a fluted filter. The adsorbent was subsequently dried at 120° C. for 16 hours in a dark drying oven. The adsorbent comprised 2.1% by weight of Ag (based on the total mass of the adsorbent).

### Example 2

### Ag-Zeolite Shaped Bodies

A solution of AgNO₃ (22.4 g in water, 100 ml total) was placed in a glass beaker. The zeolite (65 g of molar sieve 13× in the form of spheres having a diameter of 2.7 mm, molar SiO₂/Al₂O₃ ratio=2, Na form) was placed in the apparatus. 400 ml of water were then introduced and were circulated by pumping at room temperature in a continuous plant. The silver nitrate solution was added dropwise over a period of 1 hour. The mixture was then circulated by pumping overnight (23 h). The adsorbent was then washed free of nitrate with 12 liters of deionized water and was subsequently dried overnight at 120° C. in a dark drying oven. The adsorbent comprised 15.9% by weight of Ag (based on the total mass of the adsorbent).

### Example A

All ppm figures in this document are by weight.

To test the desulfurization, 10 g of the adsorbent (cf. the table below) was in each case baked overnight at 150° C. in a drying oven to remove adsorbed water. After the solid had cooled, it was taken from the drying oven and 300 ml of ethanol (absolute ethanol, >99.8%, source: Riedel de Haën) were poured over it. About 17 ppm of dimethyl sulfide (corresponds to about 9 ppm of sulfur) had been added to the ethanol, since preliminary experiments showed that dimethyl sulfide is a sulfur compound representative of the organic sulfur compounds present in bioethanol.

The Ag/ZSM-5 adsorbent was prepared by ion exchange of the Na-ZSM-5 with an aqueous AgNO₃ solution (50 g of ZSM-5, 1.94 g of AgNO₃, 50 ml of impregnation solution). A commercially available ZSM-5 (molar SiO₂/Al₂O₃ ratio=40-48, Na form, ALSI-PENTA®) was used for this purpose. The catalyst was subsequently dried at 120° C.

The Ag/SiO₂ adsorbent was prepared by impregnating SiO₂ (BET about 170 m²/g, Na₂O content: 0.4% by weight) with an aqueous AgNO₃ solution (40 g of SiO₂, 1.6 g of AgNO₃, 58 ml of impregnation solution). The catalyst was subsequently dried at 120° C. and calcined at 500° C.

The Ag/Al₂O₃ adsorbent was prepared by impregnating gamma-Al₂O₃ (BET about 220 m²/g) with an aqueous AgNO₃ solution (40 g of Al₂O₃, 1.6 g of AgNO₃, 40 ml of impregnation solution). The catalyst was subsequently dried at 120° C. and calcined at 500° C.

The ethanol/adsorbent suspension was transferred to a 4-neck glass flask into which nitrogen was passed for about 5 minutes to make it inert. The flask was subsequently closed and the suspension was stirred at room temperature for 5 hours. After the experiment, the adsorbent was filtered off by means of a fluted filter. The sulfur content of the filtrate and, if appropriate, of the adsorbent was determined coulometrically:

S content/ppm

| | | | Fresh | |
|---|---|---|---|---|
| Adsorbent | Input | Output | adsorbent | Laden adsorbent |
| Ag/ZSM-5 | 9 | <2 | 25 | 230 |
| ZSM-5 | 9 | 4 | n.d. | n.d. |
| Ag/Al₂O₃ | 9 | 2 | n.d. | n.d. |
| Ag/SiO₂ | 9 | 4 | n.d. | n.d. |

(n.d. = not determined)

The table shows that the silver-laden zeolite in particular was able to reduce the sulfur content to values below the detection limit (=2 ppm).

After the same Ag/ZSM-5 sample had been used three times, <2 ppm of sulfur were detected in the ethanol after carrying out the experiment.

Even in the case of the adsorbent in which silver had been applied to other supports such as Al₂O₃ or SiO₂, desulfurization was observed. Even the undoped zeolite led to some removal of sulfur from the ethanol. The best result was obtained using the silver-doped zeolite.

Other materials such as Cu/ZnO/Al₂O₃ catalyst or Ni catalyst were also suitable for removing S from bioethanol, but not as good as the silver-doped zeolite even when the treatment was carried out at elevated temperature with addition of hydrogen.

### Examples B

### Example B1

To test the desulfurization, 20 g of the pulverulent adsorbent Ag-ZSM5, 2.1% by weight of Ag, was used (cf. Example 1) and 300 ml of ethanol (absolute ethanol, >99.8%, source: Riedel de Haën) were poured over it. About 175 ppm of dimethyl sulfide (>99%, Merck) (corresponds to about 90 ppm of sulfur) had been added to the ethanol, since preliminary experiments showed that dimethyl sulfide is a sulfur compound representative of the organic sulfur compounds present in bioethanol. The ethanol/adsorbent suspension was transferred to a closed 4-neck glass flask. The suspension was stirred at room temperature and atmospheric pressure. After the experiment, the adsorbent was filtered off via a fluted filter. The sulfur content of the input, filtrate and, if appropriate, the adsorbent was determined coulometrically. The same Ag-ZSM5 sample was used another three times:

| | Residence | | | |
|---|---|---|---|---|
| | time | Input | Output | Laden adsorbent |
| Use | Hours | S ppm | S ppm | S ppm |
| 1 | 5 | 84 | <2 | 1300 |
| 2 | 24 | 84 | <2 | 2800 |
| 3 | 24 | 95 | 10 | 4600 |
| 4 | 24 | 97 | 29 | 5900 |

### Example B2

To test the desulfurization, 300 ml of ethanol (absolute ethanol, >99.8%, Riedel de Haën) were poured over pulverulent desulfurization materials. About 175 ppm of dimethyl sulfide (>99%, Merck) (corresponds to about 90 ppm of sulfur) had been added to the ethanol. The ethanol/adsorbent suspension was transferred to a closed 4 neck glass flask. The suspension was stirred at room temperature and atmospheric pressure for 24 hours. After the experiment, the adsorbent was filtered off via a fluted filter. The sulfur content of the input, filtrate and, if appropriate, the adsorbent was determined coulometrically.

| | Adsorbent | | | Laden |
|---|---|---|---|---|
| | % by | Input | Output | adsorbent |
| Adsorbent | weight | S ppm | S ppm | S ppm |
| 40 CuO/40 ZnO/20 Al₂O₃, | 8.5 | 84 | 64 | 22 |
| in % by weight | | | | |
| 17 NiO/15 SiO₂/5 Al₂O₃/5 | 8.5 | 95 | 58 | 9 |
| ZrO₂, in % by weight | | | | |
| 5% by weight Pd/C | 2.5 | 100 | 39 | 2300 |
| 2nd use of the Pd/C adsorbent | | 97 | 60 | 3000 |

The materials CuO—ZnO/Al₂O₃ and NiO/SiO₂/Al₂O₃ZrO₂ are suitable for desulfurization, but are not as good as, for example, a silver-doped zeolite, even when the treatment was carried out at elevated temperature and with addition of hydrogen. If palladium on carbon is used, sulfur is taken up from ethanol.

### Example B3

To test the adsorbent, a continuous fixed-bed plant having a total volume of 192 ml was charged with 80.5 g of Ag-13X spheres (15.9% by weight of Ag, 2.7 mm spheres, described in Example 2). About 80 ppm of dimethyl sulfide (>99%, Merck) (corresponds to about 40 ppm of sulfur) were added to the feed ethanol (absolute ethanol, >99.8%, Riedel de Haën). The feed was passed over the adsorbent in the upflow mode. During sampling, the sample flask was always cooled in an ice/salt mixture.

| | Cumulative loading | | |
|---|---|---|---|
| Time of | (ppm of S/g of | | |
| operation | adsorbent) | Input S ppm | Output S ppm |
| 24 | 934 | 38 | <2 |
| 48 | 1623 | 41 | <2 |
| 72 | 2222 | 42 | <2 |

The determination of sulfur in the input and output was carried out (in all examples) coulometrically (DIN 51400 Part 7) with a detection limit of 2 ppm.

### Example B4

To test the desulfurization, 500 ml of ethanol (absolute ethanol, >99.8%, Riedel de Haën) were in each case poured over 4 g of the adsorbent (cf. the table below). About 390 ppm of dimethyl sulfide (>99%, Merck) (corresponds to about 200 ppm of sulfur) had been added to the ethanol.

The preparation of Ag-13X is described in Example 1. CBV100 and CBV720 are zeolite-Y systems. The doping with metals was carried out by cation exchange in a manner analogous to Example 1 using AgNO₃ or CuNO₃ solutions. The Cu-CPV720 was subsequently calcined at 450° C. in N₂.

The ethanol/adsorbent suspension was transferred to a 4-neck glass flask and stirred at room temperature under atmospheric pressure for 24 hours. After the experiment, the adsorbent was filtered off via a fluted filter. The sulfur content of the filtrate and, if appropriate, of the adsorbent was determined coulometrically:

| | | S contents/ppm | | |
|---|---|---|---|---|
| Adsorbent | Form | Input | Output | Laden adsorbent |
| None | — | 200 | 170 | — |
| Ag-13X | Spheres (2.7 mm) | 200 | 96 | n.d. |
| Ag-CBV100 | Powder | 190 | 13 | 18000 |
| Ag-CBV720 | Powder | 190 | 77 | n.d. |
| Cu-CBV720 | Powder | 190 | 97 | 390 |

(n.d. = not determined)

The table shows that both silver-doped zeolites and copper-doped zeolites are able to desulfurize ethanol.

### EXAMPLE

Various commercial bioethanol grades were analyzed to determine their sulfur content.

| | Bio- | Bio- | Bio- | Bio- | Bio- | Bio- | |
|---|---|---|---|---|---|---|---|
| | EtOH 1 | EtOH 2 | EtOH 3 | EtOH 4 | EtOH 5 | EtOH 6 | Bio-EtOH 7 |
| Total S | 0.6 | 1 | 0.6 | 8 | 2 | 49 | 2 |
| (ppm by weight) | | | | | | | |
| Sulfate S | 0.33 | 0.43 | 0.2 | n.d. | 0.9 | 6 | 2 |
| (ppm by weight) | | | | | | | |

Total S = Total sulfur, determined coulometrically in accordance with DIN 51400 Part 7 Total sulfur contents ≦2 ppm were determined by the Wickbold method (DIN EN 41)
Sulfate S = Sulfate sulfur, determined by ion chromatography using a method analogous to that of EN ISO 10304-2

1. A method of reducing the concentration of sulfur and/or a compound comprising sulfur in a biochemically prepared organic compound selected from an alcohol, ether or a carboxylic acid, the method comprising, contacting the prepared organic compound into contact with an adsorbent in the liquid phase.

2. The method according to claim 1, wherein the organic compound is prepared by fermentation.

3. The method according to claim 1, wherein the compounds comprising sulfur is selected from the group consisting of C₂₋₁₀-dialkyl sulfides, C₂₋₁₀-dialkyl sulfoxides, 3-methylthio-1-propanol and S-comprising amino acids.

4. The method according to claim 1 wherein the compound comprising sulfur is dimethyl sulfide.

5. The method according to claim 1, wherein the biochemically prepared organic compound is selected from the group consisting of ethanol, 1,3-propanediol, 1,4-butanediol, 1-butanol, glycerol, tetrahydrofuran, lactic acid, succinic acid, malonic acid, citric acid, acetic acid, propionic acid, 3-hydroxypropionic acid, butyric acid, formic acid and gluconic acid.

6. The method according to claim 1, wherein the adsorbent is selected from the group consisting of a silica gel, aluminum oxide, a zeolite, activated carbon and carbon molecular sieve.

7. The method according to claim 1, wherein the absorbent is a zeolite selected from the group consisting of natural zeolites, faujasite, X-zeolite, Y-zeolite, A-zeolite, L-zeolite, ZSM 5 zeolite, ZSM 8 zeolite, ZSM 11 zeolite, ZSM 12 zeolite, mordenite, beta-zeolite, pentasil zeolite, Metal Organic Frameworks (MOF) and mixtures thereof which comprise ion-exchangeable cations.

8. The method according to claim 7, wherein the zeolite has a molar SiO₂/Al₂O₃ ratio from 2 to 100.

9. The method according to claim 7, wherein cations of the zeolite have been completely or partly replaced by metal cations.

10. The method according to claim 1, wherein the adsorbent comprises one or more transition metals, in elemental or cationic form, from Group VIII, Group IB or mixtures thereof, of the Periodic Table.

11. The method according to claim 10, wherein the adsorbent comprises silvers copper or silver and copper.

12. The method according to claim 10, wherein the adsorbent comprises from 0.1 to 75% by weight of the metal or metals.

13. The method according to claim 1, wherein the biochemically prepared organic compound contacts the adsorbent at a temperature from 10 to 200° C.

14. The method according to claim 13, wherein the biochemically prepared organic compound is contacts the adsorbent at an absolute pressure from 1 to 200 bar.

15. The method according to claim 1, wherein the concentration of sulfur or sulfur-comprising compounds is reduced by 90% by weight or greater (calculated as S).

16. The method according to claim 1, wherein the concentration of sulfur or sulfur-comprising compounds is reduced by 95% by weight or greater (calculated as S).

17. The method according to claim 1, wherein the concentration of sulfur or sulfur-comprising compounds is reduced by 98% by weight (calculated as S).

18. The method according to claim 1, wherein the concentration of sulfur or sulfur-comprising compounds is reduced to less than 2 ppm by weight (calculated as S).

19. The method according to claim 1, wherein the concentration of sulfur or sulfur-comprising compounds is reduced to less than 1 μm by weight (calculated as S).

20. The method according to claim 1, wherein the concentration of sulfur or sulfur-comprising compounds is reduced to less than 0.1 ppm by weight (calculated as S).

21. The method according to claim 1, wherein the contacting the prepared organic compound is conducted in the absence of hydrogen.

22. Ethanol produced from agricultural products by fermentation comprising:
a content of sulfur and/or organic compounds comprising sulfur from 0 to 0.1 ppm by weight (calculated as S),
a content of C₃₋₄-alkanols from 1 to 5000 ppm by weight,
a methanol content from 1 to 5000 ppm by weight,
an ethyl acetate content from 1 to 5000 ppm by weight, and
a 3-methyl-1-butanol content from 1 to 5000 ppm by weight.

23. Ethanol according to claim 22 wherein the content of C₃₋₄-alkanols is from 5 to 3000 ppm by weight.

24. Ethanol according to claim 22, wherein the methanol content is from 5 to 3000 ppm by weight.

25. Ethanol according to claim 22, wherein the ethyl acetate content is from 5 to 3000 ppm by weight.

26. Ethanol according to claim 22, wherein the 3-methyl-1-butanol content is from 5 to 3000 ppm by weight.

27. The use of ethanol according claim 22 as solvent, disinfectant, as a component in pharmaceutical or cosmetic products or in foodstuffs or in cleaners, as feed in steam reforming processes for the synthesis of hydrogen or in fuel cells or as building block in chemical synthesis.

28. The method according to claim 3, wherein the biochemically prepared organic compound is selected form the group consisting of ethanol, 1,3-propanediol, 1,4-butane-diol, 1-butanol, glycerol, tetrahydrofuran, lactic acid, succinic acid, malonic acid, citric acid, acetic acid, propionic acid, 3-hydroxypropionic acid, butyric acid, formic acid or gluconic acid.

29. Ethanol according to claim 23, wherein the methanol content is from 5 to 3000 ppm by weight.

30. Ethanol according to claim 29, wherein the methanol content is from 5 to 3000 ppm by weight, the ethyl acetate content is from 5 to 3000 ppm by weight, the ethyl acetate content is from 5 to 3000 ppm by weight, and the 3-methyl-1-butanol content is from 5 to 3000 ppm by weight.
